(19) United States
(12) Patent Application Publication
(10) Pub. No.: US 2003/0188711 A1
(43) Pub. Date: Oct. 9, 2003

(54) Rotary engine

(76) Inventor: Jung-Kuang Chou, Taipei Hsien (TW)

Correspondence Address: DENNISON, SCHULTZ & DOUGHERTY, 612 Crystal Square 4, 1745 Jefferson Davis Highway, Arlington, VA, 22203-3417, US

(21) Appl. No.: 10/392,859

(22) Filed: Mar. 21, 2003

(30) Foreign Application Priority Data
Apr. 3, 2002 (TW) 091106692

(51) Int. Cl. F02B 53/04

(52) U.S. Cl. 123/228

(57) ABSTRACT

An engine at least has a slide block allocated around or at a lateral side of a round gas wheel. The central portion of the gas wheel is fixedly mounted on a main axle; the gas wheel outputs kinetic force during rotating, and is provided peripherally with equidistantly arranged inverted triangular pistons; the inner side of the slide block has correspondingly an intake chamber and a combustion chamber opposite to pistons on the gas wheel to form quasi cylinders. The slide block has on its outer surface an arciform slide way forming an inclined angle θ with the contrary direction of rotation of the gas wheel and being supported by pulleys provided on a supporting rack; a spring and a screw are provided at the opening end of the inclined angle θ for adjusting the basic micro pressure between the slide block and the gas wheel to prevent the slide block from sliding off along the normal rotating direction. In cooperation with a reaction force, the inclined angle θ makes the slide block able to keep tight connecting with the gas wheel, and able to be adapted to changing of the air pressure and the expansion & contracting by heating and cooling to automatically float at the balance point between the rotating force and the centrifugal force. Thereby, the pressure between the slide block and the gas wheel is approaching zero; this can elevate the combustion temperature for increasing efficiency.

### BACKGROUND OF THE INVENTION

1. Field of the Invention

The present invention is related to a rotary engine; and especially to such a rotary engine which is supplied with high-pressure combustible gas from outside, the gas is burned to generate kinetic force, an air compressor with matched energy can be selected for rotating to absorb fuel and air and outputs high-pressure combustible gas to be used by the rotary engine provided that a motor is added and activated, besides, it is suitable for converting the dynamic fluid energy such as high-pressure and high-temperature waste gas, water vapor, compressed air etc. generated from combustion into mechanic kinetic force.

2. Description of the Prior Art

As to conventional engines, except airplanes and steamships requiring those faster jet engines and turbine engines with larger horsepower, land vehicles widely use reciprocating piston engines, they are characterized in that their torques are normal in low rotation speeds. The jet engines get high accumulated temperature from sustaining combustion, their mixture ratios of air are more stable, efficiencies of combustion are better, volumes are smaller and horsepower is larger, these are advantages of them; however, they are deficient in the inferior torques in low rotation speeds.

The rotary piston engine invented by the German engineer Wan Kel in 1957 is structurally simple with small volume, light weight and low noise; although it had these advantages, it is also deficient in the inferior torques in low rotation speeds, hence it has not widely been used in lieu of the conventional reciprocating piston engines. A reciprocating piston engine generally has to have a suitable clearance between the piston and the cylinder thereof for rotation, thereby, it must be cooled to be controlled at the state of low-temperature rotation to prevent strain by expansion & contracting by heating and cooling, the total heat consumption thereof is about 60% of the total amount of fuel, and the effective rate of use thereof is about 30%.

And more, an intermittent intake system is not easy in controlling the mixture ratio of air to fuel, a low combustion temperature is subject to air contamination, and each time the cylinder has a larger explosion amount, higher noise, larger vibration, more complicated control, and relatively, its structure is heavier, bigger and more consolidated. By virtue that explosion has some limitations, the internal diameter of the cylinder is preferably not larger than 15 cm; hence a gasoline engine with larger horsepower mostly is composed of multiple cylinders, the performance of acceleration of it is inferior, it is added with mixed gas once every one or two turns of rotation, the amount that can be added is limited, and is hard to elevate the combustion temperature for increasing efficiency.

### SUMMARY OF THE INVENTION

The primary object of the present invention is to provide a rotary engine getting rid of the limitation of a conventional engine by the clearance of a piston; it can avoid the defects of the limitation by the low temperature rotation, the intermittent gas intake and discharging to elevate the combustion temperature for increasing efficiency.

To achieve the above stated object, the present invention at least has a slide block allocated around or at a lateral side of a round gas wheel. The central portion of the gas wheel is fixedly mounted on a main axle, the gas wheel outputs kinetic force during rotating. The gas wheel is provided peripherally with a plurality of equidistantly arranged inverted triangular pistons; and the inner side of the slide block is provided correspondingly with an intake chamber and a combustion chamber, the intake chamber and the combustion chamber are opposite to pistons on the gas wheel to form quasi cylinders. The slide block has on the outer surface thereof an arciform slide way forming an angle θ with the contrary direction of rotation of the gas wheel and being supported by pulleys provided on a supporting rack; a spring and a screw are provided at the opening end of the inclined angle θ for adjusting the basic micro pressure between the slide block and the gas wheel to prevent the slide block from sliding off along the normal rotating direction. In cooperation with a reaction force, the inclined angle θ of the present invention makes the slide block able to keep tight connecting with the steam turbine, and able to be adapted to changing of the air pressure and the expansion & contracting by heating and cooling to automatically float at the balance point between the rotating force and the centrifugal force. Thereby, the pressure between the slide block and the gas wheel is approximately zero; this can elevate the combustion temperature for increasing efficiency.

The present invention will be apparent in its detailed structure and features after reading the detailed description of the preferred embodiment thereof in reference to the accompanying drawings.

### BRIEF DESCRIPTION OF THE DRAWINGS

FIG. 1 is a perspective view of an embodiment of the present invention;

FIG. 2 is a top view the embodiment of the present invention;

FIG. 3 is an analytic perspective view showing the elements of the embodiment of the present invention;

FIG. 4 is a sectional view of the embodiment of the present invention partially assembled;

FIG. 5 is a vector analysis diagram of the present invention in application.

### DETAILED DESCRIPTION OF THE PREFERRED EMBODIMENT

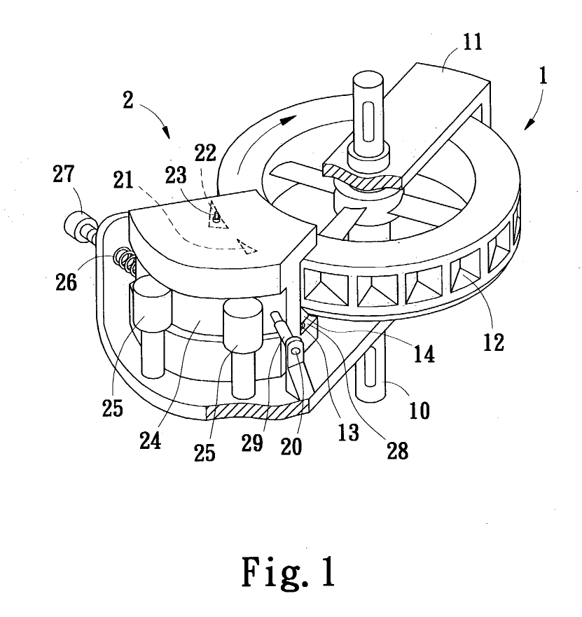

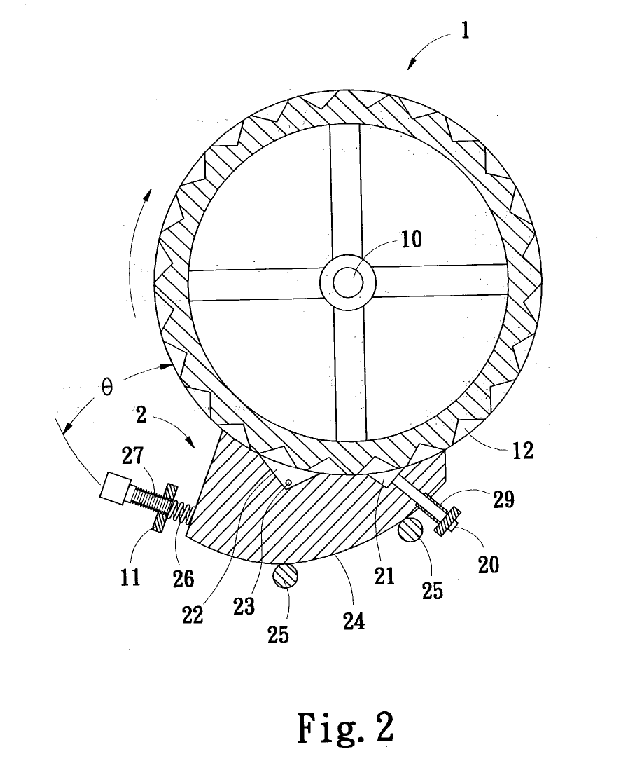

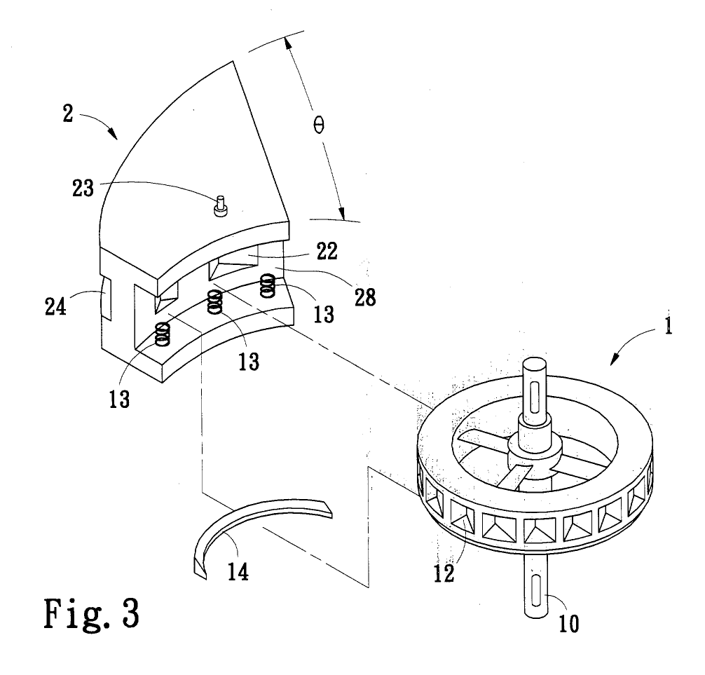

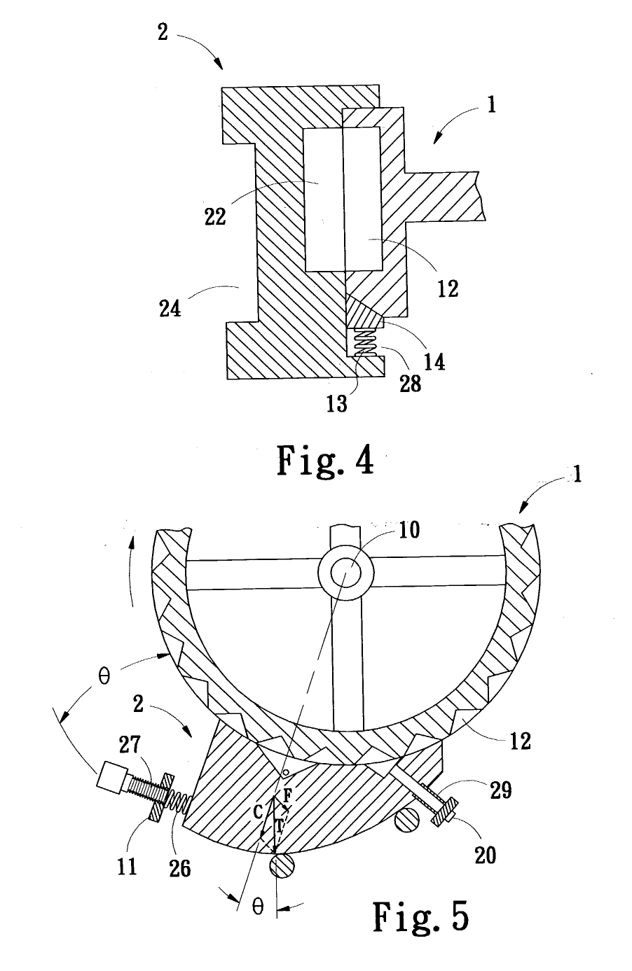

Referring simultaneously to FIGS. 1-5, the present invention is provided with a round gas wheel 1 of which the central portion is fixedly mounted on a main axle 10, the gas wheel 1 outputs kinetic force during rotating. The gas wheel 1 is provided peripherally with a plurality of equidistantly arranged pistons 12 each in the shape of an inverted triangular concavity. The gas wheel 1 has at least a slide block 2 allocated at a lateral side thereof; the slide block 2 keeps tight connecting with the gas wheel 1 when in a static state, and is provided on one side thereof with a wide groove 28 able to slip over the periphery of the gas wheel 1. The wide groove 28 further has a press strip 14 and spring 13, and has the functions of adapting to expansion & contracting by heating and cooling as well as preventing gas leakage. The wide groove 28 is provided on the bottom thereof with inverted triangular concavities that are respectively an intake chamber 21 and a combustion chamber 22 opposite to pistons 12 on the gas wheel 1 to form quasi cylinders.

The slide block 2 has on the outer surface thereof an arciform slide way 24 of which the radius is same as that of the gas wheel 1; the arciform slide way 24 forms an angle θ with the contrary direction of rotation of the gas wheel 1, and is supported by a plurality of pulleys 25 distributed on the arciform slide way 24, the pulleys 25 are provided on a supporting rack 11. A spring 26 and a screw 27 are provided at the opening end of the inclined angle θ for adjusting the small pressure applied on the slide block 2 to force it to bear a small pressure and to be pushed toward the gas wheel 1 for keeping tight connecting of it with the gas wheel 1, and to prevent the slide block 2 from sliding off along the normal rotating direction.

The smaller the inclined angle θ is, the larger the pressure between the gas wheel 1 and the slide block 2 will be, and; the best state is that the pressure is approaching to zero, then the best efficiency can be obtained, this depends on the micro pushing force made by the spring 26 and the screw 27 to keep tight connecting of the gas wheel 1 with the slide block 2.

The combustion chamber 22 has a spark plug 23 being continuously ignited for combustion, it sustains to generate kinetic force; an action force forms a 90 degree angle with the arm (radius) of force of the gas wheel 1, this makes the most direct transmitting, and most meets the principles of vector mechanics, thereby its loss of kinetic force is the least. And more, its arm of force is long; hence it can obtain a high torque even when in a low air pressure. By virtue that it has a higher temperature of combustion, it can get the same effect when in a lower ratio of compression; but the rotation speed of the engine is smaller, the ratio of compression can be changed to adjust the rotation speed.

As to the rotating force F in FIG. 5, it is calculated according to the areas generating the pushing force of the inverted triangular concavities, this is equal to the area of one side of a triangle formed of the force components; while as to the centrifugal force C, it is calculated according to the areas of the openings of the inverted triangular concavities, this is the area of the bottom side of the abovementioned triangle of the force components; and the magnitude of the inclined angle θ is determinative by the ratio of magnitude of the rotating force F to the centrifugal force C. Provided that the two forces are equal, the inclined angle θ is about 45 degrees; when the centrifugal force C is larger, the inclined angle θ must be smaller for resisting the pushing force; on the contrary, when the centrifugal force C is smaller, the inclined angle θ can be larger to about the extent that makes the two forces balance with each other. Occasionally, the slide block 2 is slightly separated from gas wheel 1 provided the expansion is caused and the slide block 2 is in motion simultaneously, then is pushed back to restore the original inclined angle θ along a contrary rotating direction by reaction force; according to this theory, the slide block 2 can automatically adjust the pressure and displacement to get the best effect. The two triangles correspond with each other to form a cylinder, gas with high pressure can be created interiorly of them, it is not a pushing force for work actually, in this view, the combustion chamber 22 of the present invention must be elongated to straddle more than one piston 12; in principle, its volume must have a space for extending, and a thrust can then be generated to rotate. The tight connecting area therebetween the slide block 2 and gas wheel 1 set with the intake chamber 21 and the combustion chamber 22 formed from inverted triangular concavities respectively with a distance therebetween larger than length of the opening of a piston 12, this can prevent the piston 12 from straddling the two chambers or from outward gas leakage to affect the torque in a low speed.

In conclusion, the present invention discloses a rotary engine to get rid of the defects resided in a conventional engine of which the low combustion temperature is subjected to air contamination and the performance of acceleration of it is inferior, and to elevate the combustion temperature for increasing efficiency of the rotary engine that is novel and industrially utilizable.

The embodiment given is only for illustrating the present invention, it will be apparent to those skilled in this art that various modifications or changes without departing from the spirit of this invention shall also fall within the scope of the appended claims.

1. A rotary engine comprising:
at least a slide block allocated around or at a lateral side of a round gas wheel, the central portion of said gas wheel is fixedly mounted on a main axle, said gas wheel outputs kinetic force during rotating; said gas wheel is provided peripherally with a plurality of equidistantly arranged inverted triangular pistons; and the inner side of said slide block is provided correspondingly with an intake chamber and a combustion chamber both being concavities also in inverted triangular shapes, said intake chamber and said combustion chamber are opposite to said pistons on said gas wheel to form quasi cylinders; said slide block has on the outer surface thereof an arciform slide way of which the radius is same as that of said gas wheel, the arciform slide way forming an inclined angle with the contrary direction of reaction of said gas wheel, is supported by a plurality of pulleys; thereby the reaction force is always keeping tight connection with said gas wheel due to the contracting, and an action force is caused when expansion of said gas wheel.

2. The rotary engine as in claim 1, wherein a central combustion chamber is provided to afford rotation of multiple engines with a plurality of pipe lines; alternatively, said rotary engine is provided with a plurality of slide blocks to increase horsepower.

3. A closed intake and discharging system, wherein the distance between said intake chamber and said combustion chamber is larger than the length of the opening of any of said pistons, this prevents said piston from straddling both said intake and combustion chambers or from outward gas leakage to affect the torque in a low speed.

4. The closed intake and discharging system as in claim 3, wherein the space of said piston is integrally formed with a predetermined volume.

5. The closed intake and discharging system as in claim 3, said system overcomes the hinder induced by high temperature, and is suitable for converting dynamic gas energy without fuel or without a combustion chamber into kinetic force.
